(19) United States
(12) Patent Application Publication
(10) Pub. No.: US 2023/0004230 A1
(43) Pub. Date: Jan. 5, 2023

(54) ELECTRONIC DEVICE AND METHOD FOR DISPLAYING DATA ON A DISPLAY SCREEN, RELATED DISPLAY SYSTEM, VEHICLE AND COMPUTER PROGRAM

(71) Applicant: FAURECIA INTERIEUR INDUSTRIE, Nanterre (FR)

(72) Inventors: Nicolas PEGORIER, PARMAIN (FR); Fabrice AYCOBERRY, SAINT GERMAIN EN LAYE (FR)

(21) Appl. No.: 17/856,278

(22) Filed: Jul. 1, 2022

(30) Foreign Application Priority Data
Jul. 2, 2021 (FR) FR 21 07196

(51) Int. Cl. G06F 3/01; G06T 7/246

(52) U.S. Cl. CPC G06F 3/017; G06F 3/011; G06T 7/248; G06T 2207/30196

(57) ABSTRACT

An electronic device for displaying data on a display screen, the device being connectable to the display screen and to an image sensor, the image sensor being operable to capture at least two images of a user. The electronic device includes: a module for displaying data, in particular icons, on the display screen; a module for detecting, via the at least two images taken, a movement towards the screen by at least one finger of the user, and then for calculating a direction of the movement; a module for determining, from a page displayed on the screen and depending on the direction of movement, an area of the screen corresponding to the direction; and a module for controlling an enlargement of the area when the at least one finger approaches the screen.

### CROSS-REFERENCE TO RELATED APPLICATIONS

This application is a U.S. non-provisional application claiming the benefit of French Application No. 21 07196, filed on Jul. 2, 2021, which is incorporated herein by reference in its entirety.

### TECHNICAL FIELD

The present invention relates to an electronic device for displaying data on a display screen, the device being adapted to be connected to the display screen and to an image sensor, the image sensor being adapted to take at least two images of a user of the display screen. The device includes a display module configured to display data, in particular icons, on the display screen.

The invention also relates to an electronic data display system, the system comprising a display screen, an image sensor adapted to take at least two images of a user of the display screen, and such an electronic device for displaying data on the display screen.

The invention also relates to a vehicle, in particular a motor vehicle, comprising such an electronic system for displaying data.

The invention also relates to a method for displaying data on a display screen, the method being implemented by such an electronic display device; and to a non-transitory computer-readable medium including a computer program comprising software instructions which, when executed by a computer, implement such a display method.

The invention relates to the field of human-machine (or man-machine) interfaces, also known as HMI or MMI, and in particular to electronic data display systems for the user.

The invention also relates to the field of vehicles, in particular automobiles, wherein the electronic display system described above is more particularly configured to be carried on board a vehicle, such as a motor vehicle, and the user then typically being the driver of the vehicle.

### BACKGROUND

EP 2 474 885 A1 provides an information display device including a screen with a capacitive touch screen function, wherein a sensor measures a capacitance change of the screen, and then provides the measured capacitance change and positional information of the capacitance change to a controller which then determines whether or not a finger is in proximity to the screen based on the capacitance change provided by the sensor. If it is determined that the finger is in the vicinity of the screen, the on-screen coordinates corresponding to the position of the finger are determined on the basis of the positional information provided by the measurement sensor, and an area displayed on the screen centered on these determined coordinates is then enlarged so as to facilitate selection of the object under the finger, this enlargement being maintained for as long as the finger is detected as being in the vicinity of the screen.

U.S. Pat. No. 9,772,757 B2 also describes a display device with a touch screen, in which an area displayed on the screen is enlarged when the presence of a user's finger near the screen is detected. This document also teaches how to change the magnified area when the user's finger moves parallel to the touch screen.

However, with such displays, the interaction between the user and the display is not always optimal, and a tactile selection of an icon displayed on the screen is sometimes tricky, resulting in a cognitive load for the user.

### SUMMARY

One purpose of the invention is then to provide an electronic device, and an associated method, for displaying data on a display screen, allowing the selection of an icon displayed on the screen to be facilitated, and thus reducing the cognitive load for the user, which makes it possible to reduce the risks of an accident in a vehicle when the electronic display device is on board this vehicle and the user is then typically the driver of said vehicle.

To this end, the invention relates to an electronic device for displaying data on a display screen, the device being adapted to be connected to the display screen and to an image sensor, the image sensor being adapted to capture at least two images of a user of the display screen, the device comprising:
a display module configured to display the data, in particular icons, on the display screen;
a detection module configured to detect, via the at least two images taken, a movement towards said screen by at least one finger of the user, and then to calculate a direction of the movement;
a determination module configured to determine, from a page displayed on the screen and depending on the direction of movement, an area of the screen corresponding to said direction; and
a control module configured to control an enlargement of said area when said at least one finger approaches the screen.

With this electronic display device, the detection module makes it possible, via the at least two images taken by the image sensor, to detect when the user is moving at least one of their fingers toward the display screen, and to detect in particular the movement of the at least one finger in the direction of the screen, and then to calculate the direction of said movement. The determination module is then used to determine an area displayed on the screen from the direction of movement calculated via the at least two captured images; and the control module is then used to modify the appearance of said area, in particular to enlarge said area, when said at least one finger approaches the screen, in order to facilitate the user's subsequent selection of an item included in that area, such as an icon.

The skilled person will in particular understand that this detection of the movement of the at least one finger towards the screen, carried out on the basis of the at least two images taken by the image sensor, allows for early detection, compared to a detection carried out via a capacitive sensor with the display device of the state of the art.

Preferably, movement detection is performed as soon as a distance between the at least one finger of the user and the display screen is less than a predefined detection threshold, this detection threshold being for example less than 10 cm, and preferably less than 5 cm.

Even more preferably, the enlargement of the area pointed to by the at least one finger of the user, i.e. in the direction of movement of the at least one finger, is performed with increasing intensity as the distance between the at least one detected finger and the display screen decreases, thereby indicating to the user the area to which their finger is pointing, and this in an increasingly distinct manner as their finger approaches the screen. If this area does not correspond to what the user wishes to select, then the user can easily shift their finger laterally so that their finger points to another area, which will then result in an enlargement of that other area, corresponding to the new direction of movement of the at least one finger. The enlargement of said area is then progressive with an increasing amplification of said area enlargement as said at least one finger gets closer and closer to the screen, i.e. as the distance between the detected at least one finger and the display screen decreases.

In other beneficial aspects of the invention, the electronic display device comprises one or more of the following features, taken in isolation or in any technically possible combination:
the detection module is configured to detect a distance between said at least one finger and said screen, and the control module is configured to control the enlargement of said area when said distance is below a predefined threshold;
the movement is a substantially rectilinear movement;
the detection module is configured to calculate the direction of movement from a tip of the at least one finger; the direction of movement preferably being calculated only from the tip of the at least one finger;
the control module is configured to control the enlargement of said area with increasing intensity as said at least one finger moves closer and closer to the screen;
the control module is configured to further control highlighting and/or colour modification of said area; and
the display screen is a touch screen, and the device further comprises an acquisition module configured to acquire a touch selection, from the user, of an icon displayed in said area; the acquisition module preferably being further configured to generate a signal to the user confirming the acquisition of the selection; and the acquisition confirmation signal being preferably further selected from the group consisting of: a vibratory signal, a visual signal and an audible signal.

The invention also relates to an electronic data display system, the system comprising a display screen, an image sensor adapted to capture at least two images of a user of the display screen, and an electronic device for displaying data on the display screen, the electronic display device being as defined above, the electronic display device being connected to the display screen and the image sensor.

In other beneficial aspects of the invention, the electronic display system comprises one or more of the following features, taken in isolation or in any technically possible combination:
the system is configured to be carried in a vehicle; the vehicle preferably being a motor vehicle; and
the user is a driver of the vehicle.

The invention also relates to a vehicle, in particular a motor vehicle, comprising an electronic system for displaying data, the electronic display system being as defined above.

The invention also relates to a method for displaying data on a display screen, the method being implemented by an electronic display device adapted to be connected to the display screen and to an image sensor, the image sensor being adapted to take at least two images of a user of the display screen, the method comprising:
displaying data, in particular icons, on the display screen;
detecting, via the at least two images taken, a movement towards said screen by at least one finger of the user, and then calculating a direction of the movement;
determining, from a page displayed on the screen and depending on the direction of movement, an area of the screen corresponding to said direction; and
controlling an enlargement of said area as said at least one finger approaches the screen.

The invention also relates to a non-transitory computer-readable medium including a computer program comprising software instructions, which, when carried out by a computer, implement a display method as defined above.

### BRIEF DESCRIPTION OF THE DRAWINGS

These features and advantages of the invention will appear more clearly upon reading the following description, given solely as a non-limiting example, and made in reference to the attached drawings, in which:

FIG. 1 is a schematic representation of a vehicle, in particular a motor vehicle, comprising an electronic system for displaying data according to an embodiment of the invention, the display system comprising a display screen, an image sensor of a user of the display screen, and an electronic device for displaying data on the display screen, said device being connected to the screen and to the image sensor;
FIG. 2 represents a schematic perspective view of the interior of the vehicle of FIG. 1, with the display screen facing a user, such as the driver of the vehicle, and the image sensor adapted to take at least two images of the user, in particular when they extend one of their hands towards the screen;

FIG. 3 is a schematic representation of four interaction situations between the electronic display system of FIG. 1 and a user's finger; and
FIG. 4 is a flowchart of a method according to an embodiment of the invention for displaying data on the display screen, the method being implemented by the electronic display device of FIG. 1.

### DETAILED DESCRIPTION

In the following of the description, the phrase “substantially equal to” means being equal within 10%, and preferably within 5%.

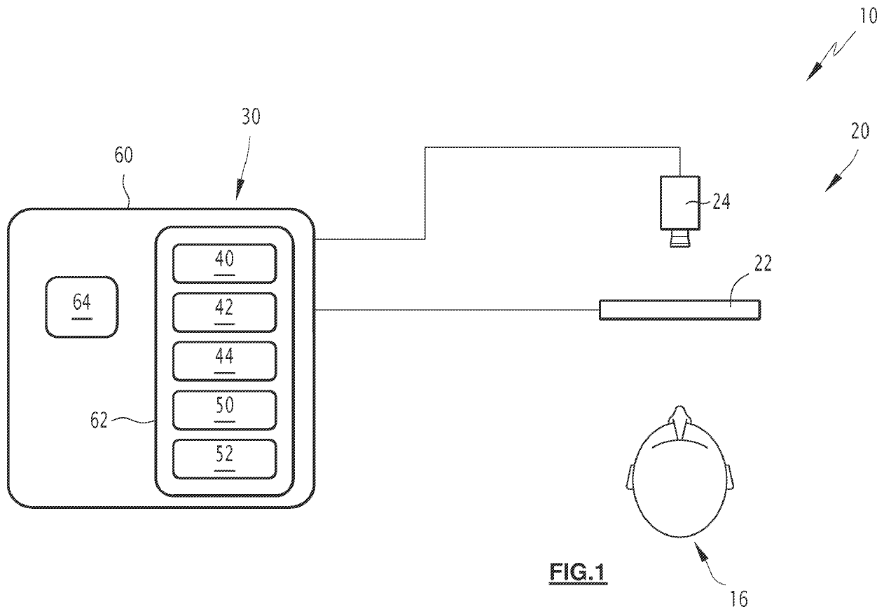

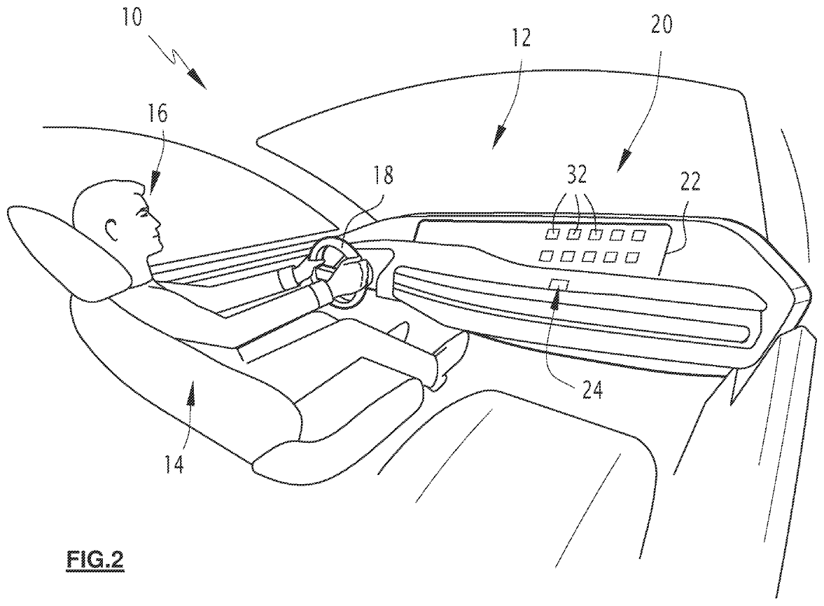

In FIGS. 1 and 2, a vehicle 10 comprises a passenger compartment 12; and within the passenger compartment 12, a seat 14 for a user 16, such as a driver, and a steering wheel 18 for driving the vehicle, as is known per se.

The vehicle 10 further comprises an electronic system 20 for displaying data to the user 16, the display system 20 being adapted to be carried on board the vehicle 10.

The skilled person will understand that the vehicle 10 is broadly understood to be a vehicle that allows a driver, also called a pilot, and additionally one or more passengers, to travel. The vehicle 10 is then typically selected from the group consisting of: a motor vehicle, such as a car, bus or truck; a rail vehicle, such as a train or tram; a marine vehicle, such as a ship; and an aviation vehicle, such as an aircraft.

The electronic display system 20 comprises a display screen 22, an image sensor 24 adapted to capture at least two images of the user 16, and an electronic device 30 for displaying data on the display screen 22, the display device 30 being connected to the screen 22 and the image sensor 24.

The display screen 22 is adapted to display data to the user 16, in particular icons 32, visible in FIGS. 2 and 3. The display screen 22 is typically a touch screen, and is then configured to detect a tactile touch against the screen from the user 16, and typically a touch by at least one finger 34 of the user against a portion of the surface of the screen 22, such as a portion of the surface where a respective icon 32 is displayed. The touch screen is for example a capacitive touch screen or a resistive touch screen, as known per se.

The image sensor 24 is known per se, and is configured to acquire at least two images of the user 16, in particular of one of the user's hands 36, and typically at least one of the user's fingers 34, in particular when the user 16 extends their hand 36 towards the display screen 22.

The image sensor 24 is, for example, positioned facing the screen 22, so that at least two images of the hand 36 can be taken when it is in the vicinity of the screen 22, and so that it is furthermore possible to determine via the at least two images taken, which is the direction of the approach movement of the hand 36, and in particular of the at least one finger 34, towards the screen 22.

The image sensor 24 is typically positioned substantially parallel to the screen 22, an axis of sight of the image sensor 24 being substantially perpendicular to the surface of the screen 22, the axis of sight itself being substantially perpendicular to an active surface, not shown, of the image sensor 24.

The electronic display device 30, shown in FIG. 1, is configured to display data on the display screen 22 to the user 16. The electronic display device 30 comprises a module 40 for displaying data, in particular icons 32, on the display screen 22.

The electronic display device 30 further comprises a module 42 for detecting, via the at least two images taken by the image sensor 24, a movement towards the screen 22 of the at least one finger 34 of the user, the detection module 42 being then configured to calculate a direction M of the detected movement; a module 44 for determining an area 48, from a page 46 displayed on the screen 22 and based on the direction M of the movement, the area 48 typically including at least one icon 32; and a module 50 for controlling a change in appearance of the determined area 48.

As an optional addition, the electronic display device 30 further comprises a module 52 for acquiring a tactile selection by the user 16 of an icon 32 displayed on the screen 22.

In the example shown in FIG. 1, the electronic display device 30 comprises an information processing unit 60 formed for example by a memory 62 and a processor 64 associated with the memory 62.

In the example shown in FIG. 1, the display module 40, the detection module 42, the determination module 44 and the control module 50, and in the optional addition the acquisition module 52, are each in the form of software, or a software brick, which can be executed by the processor 64. The memory 62 of the display device 30 is then able to store software for displaying data on the display screen 22; software for detecting, via the at least two images taken by the sensor 24, the movement towards the screen 22 of the respective at least one finger 34 of the user, and then for calculating the direction M of said movement; software for determining, from among the page 46 displayed on the screen 22 and as a function of the direction M of said movement, a respective area 48; and software for controlling a change in the appearance of the determined area 48. As an optional addition, the memory 62 of the display device 30 is able to store software for acquiring a tactile selection by the user 16 of a respective icon 32 displayed on the display screen 22. The processor 64 is then able to execute each one of the display software, the detection software, the determination software and the control software, and in the optional addition the acquisition software.

In a variant not shown, the display module 40, the detection module 42, the determination module 44 and the control module 50, and in the optional addition the acquisition module 52, are each in the form of a programmable logical component, such as a FPGA (Field-Programmable Gate Array), or as a dedicated integrated circuit, such as an ASIC (Application-Specific Integrated Circuit).

When the display device 30 is in the form of one or more software, that is to say in the form of a computer program, also called a computer program product, it is also capable of being stored on a computer-readable medium, not shown. The computer-readable medium is, for example, a medium that can store electronic instructions and be coupled with a bus from a computer system. For example, the readable medium is an optical disk, magneto-optical disk, ROM memory, RAM memory, any type of non-volatile memory (for example EPROM, EEPROM, FLASH, NVRAM), magnetic card or optical card. The readable medium in such a case stores a computer program comprising software instructions.

It will be understood by the skilled person that an icon, referred to by the general reference 32, is any graphical object intended to be displayed on the display screen 22, and in particular any graphical object capable of being tactile-selected by the user 16. In the examples of FIGS. 2 and 3, the icons 32 are—schematically and for the sake of simplification of the drawing—shown with a rectangular shape, and the skilled person will of course understand that each icon 32 may have any geometric shape, not necessarily rectangular.

The display module 40 is configured to display data, in particular icons 32, on the display screen 22. The display module 40 is known per se, and is capable of generating the graphical information corresponding to the data to be displayed, and then transmitting it to the display screen 22 for display on said screen.

The detection module 42 is configured to detect, via the at least two images of the user 16, and in particular of their hand 34, taken by the image sensor 24, a movement towards the screen 22 of the hand 36 of the user 16, and in particular of the at least one of their fingers 34. The detection module 42 is then configured to calculate the direction M of the movement of the hand 36, and in particular of the at least one finger 34, towards the display screen 22. The direction M of movement is typically calculated from an end of the at least one finger 34, i.e. a tip of the at least one finger 34; said direction M of movement preferably being calculated only from the end of the at least one finger 34. Said direction M of movement is then calculated solely from the trajectory of the tip of the or each finger 34, this trajectory being determined from said at least two images taken by the image sensor 24.

As an optional addition, the detection module 42 is configured to detect movement of the at least one finger 34 of the user 16 toward the display 22 only if a distance between the finger 34 and the display 22 is less than a predefined detection threshold. The detection threshold is, for example, less than or equal to ten centimeters, or less than or equal to five centimeters, the detection threshold typically being an integer of centimeters less than or equal to the above values.

The detection module 42 is for example configured to calculate the distance between at least one finger 34 and a reference point based on a number of pixels between the at least one finger 34 and the reference point in a corresponding image, wherein a predefined distance for two known points is associated or correlated with a predefined number of pixels as a reference or matching relationship.

As an optional addition, at least three reference points are taken into account for the calculation of said distance to make the analysis, according to the respective numbers of pixels for the same object, such as the same finger 34, with respect to the different reference points, a 3-dimensional coordinate system is created. According to this optional addition, the detection module 42 is then configured to determine, via said 3-dimensional coordinate system, the direction of movement of the object, in particular of the at least one finger 34, relative to the reference, typically associated with the screen 22. According to this optional addition, the detection module 42 is also configured to determine, via said 3-dimensional coordinate system, the distance of the object, in particular of the at least one finger 34, from the reference, typically associated with the screen 22.

The determination module 44 is configured to determine a respective area 48 of the page 46 displayed on the display screen 22, the area 48 typically including at least one icon 32, based on the direction M of the movement previously calculated by the detection module 42.

The movement is, for example, a substantially rectilinear movement. In particular, the skilled person will observe that the movement is distinct from conventional hand or multi-finger gestures, such as a pinch-to-zoom gesture, a swipe gesture, etc.

The control module 50 is then configured to control a change in an appearance of the area 48 when the at least one finger 34 approaches the screen 22.

The change in appearance of the area 48 is typically an enlargement of the area 48.

As an optional addition, the modification of the appearance of the area 48 further comprises a highlighting and/or a color modification of said area 48.

The change in appearance of the area 48 is then typically selected from the group consisting of: an enlargement of the area 48, a highlighting of the area 48, and a color change to the area 48.

In the example shown in FIG. 3, the control module 50 is configured to control a change in the size, and preferably an enlargement, of the area 48, and typically of the at least one icon 32 included in the area 48. The enlargement of the area 48 is preferably a homothety with respect to a center of the area 48. In other words, the size of the area 48 is increased in all directions. Alternatively, only one dimension of the area 48 in a single direction is increased.

In addition, the enlargement of each icon 32 is preferably a homothety with respect to a center of said icon 32. In other words, the size of the icon 32 is increased in all directions. Alternatively, only one dimension of the icon 32 in a single direction is increased.

As an optional addition, the control module 50 is configured to control said change in appearance with increasing intensity upon a decrease in a distance between the detected finger 34 and the display screen 22. In other words, according to this optional addition, the control module 50 is configured to control the change in appearance with increasing intensity as the distance between the finger 34 and the display 22 decreases.

According to this optional addition, the skilled person will understand that when the appearance modification is an enlargement, the intensity corresponds to an enlargement ratio, i.e. a ratio between the post-enlargement and pre-enlargement dimensions of the icon 32. When the appearance change is a highlight, the intensity corresponds to a highlight level, or light intensity. Where the change in appearance is a color change, the intensity corresponds, for example, to a color tone, with higher intensities typically associated with bright colors, and lower intensities with pastel colors.

As a further optional addition, the control module 50 is configured to control the change in appearance with a greater intensity for an icon 32 located near the center of the defined area 48 than for an icon located away from said center and thus closer to a peripheral edge of said defined area 48.

According to this optional addition, the control module 50 is then configured to control the change in appearance with a greater intensity for an icon 32 directly facing the at least one detected finger 34, i.e. along a pointing direction P of said finger 34, than for icons 32 on either side of said icon 32 targeted by the finger 34. The icons 32 on either side of said icon 32 targeted by the finger 34, while included within the specified area 48, also have a modified appearance relative to the icons 32 outside said area 48.

As a further optional addition, the control module 50 is configured to control said change in appearance temporarily, for example for a predefined period of time. The predefined time is for example between one tenth of a second and one second.

Alternatively, the control module 50 is configured to control said change in appearance as long as a distance between the detected finger 34 and the display screen 22 is less than a predefined hold threshold. The hold threshold is, for example, less than or equal to ten centimeters, or less than or equal to five centimeters, the hold threshold typically being equal to an integer of centimeters less than or equal to the above values.

As an optional addition, the acquisition module 52 is configured to acquire a tactile selection of a respective icon 32 displayed on the screen 22, in particular an icon 32 whose appearance is changed via the control module 50, the tactile selection, typically via a tactile touch against the screen 22, having been made by the user 16, in particular following said appearance change.

As an optional addition, the acquisition module 52 is configured to, following acquisition of said tactile selection, generate an acquisition confirmation signal to the user 16. The acquisition confirmation signal is, for example, a vibratory signal, such as a haptic signal or a mechanical vibration; a visual signal; or a sound signal. The confirmation signal then informs the user 16 that their tactile selection has been acquired and thus taken into account by the electronic display device 30.

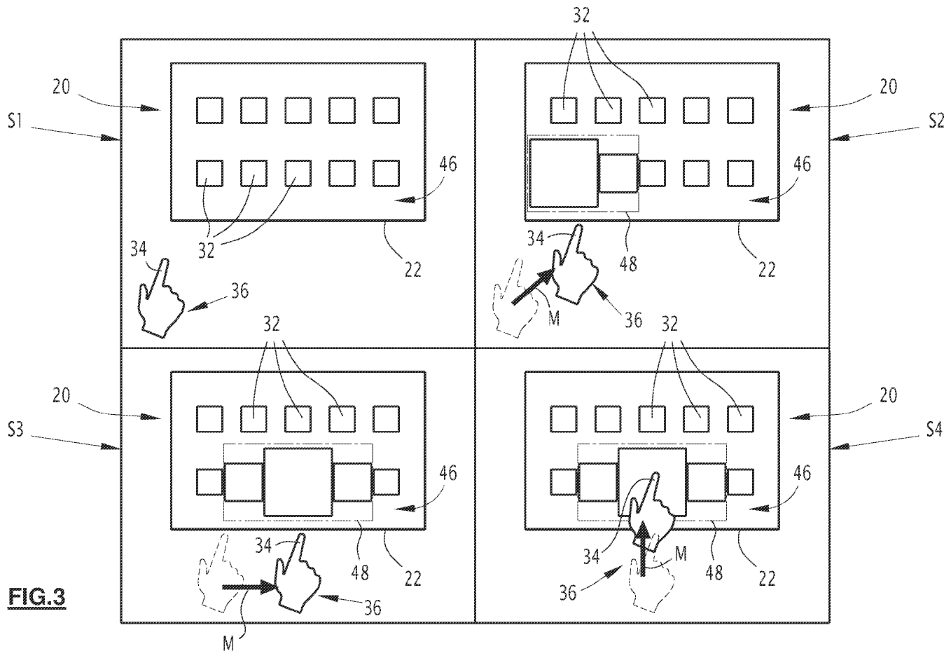

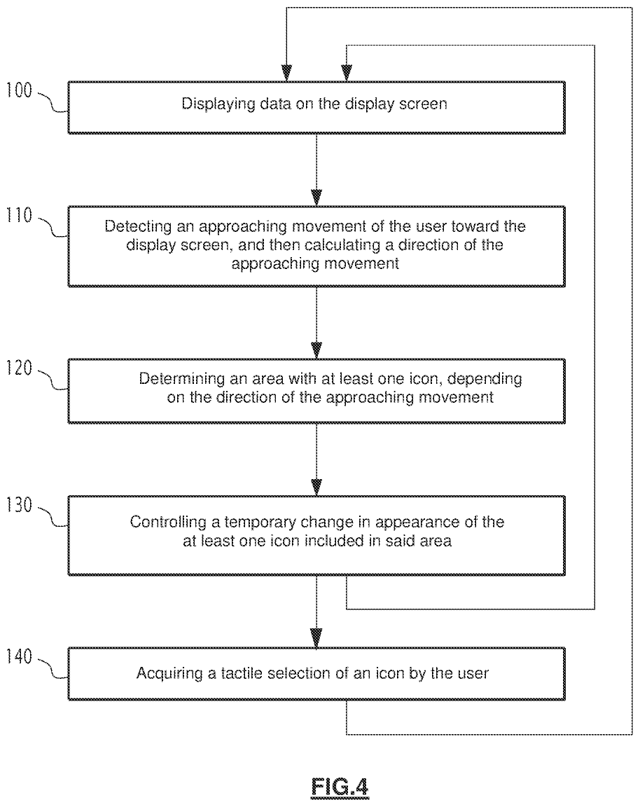

The operation of the electronic display system 20, and in particular of the electronic display device 30, will now be described with reference to FIG. 4 showing a flow chart of the method of displaying data on the display screen 22 to the driver 16.

In an initial and recurring step 100, the display device 30 displays the data, in particular icons 32, on the display screen 22 via its display module 40. As is known per se, in this display step 100, the display module 40 generates graphical information corresponding to said data and transmits it to the display screen 22 for display.

When the user 16 makes an approaching movement towards the display screen 22, in particular with one of their hands 36, and in particular with one of their fingers 34, the display device 30 then detects, in the next step 110 and via its detection module 42, this movement of the user 16 towards the display screen 22, this detection being carried out on the basis of the at least two images acquired by the image sensor 24.

As an optional addition, the detection module 42 detects the movement of the at least one finger 34 of the user 16 toward the display 22 only if the distance between the finger 34 and the display 22 is less than the predefined detection threshold. The skilled person will then understand that the distance between the finger 34 and the screen 22 is more precisely the distance between the end of the finger 34, i.e. the tip of the finger 34, and the screen 22.

In this step 110, the detection module 42 then calculates the direction M of this movement, also from the at least two images taken by the image sensor(s) 24. The direction M of movement is typically calculated from the end of the at least one finger 34, i.e. the tip of the at least one finger 34; said direction M of movement preferably being calculated only from the end of the at least one finger 34. Said direction M of movement is then calculated solely from the trajectory of the tip of the or each finger 34, this trajectory being determined from said at least two images taken by the image sensor 24.

The detection module 42 calculates, for example, the distance between at least one finger 34 and a respective reference point, based on a number of pixels between the at least one finger 34 and the reference point in a corresponding image.

As an optional addition, at least three reference points are taken into account for the calculation of said distance to make the analysis, according to the respective numbers of pixels for the same object, such as the same finger 34, with respect to the different reference points, a 3-dimensional coordinate system is created. According to this optional addition, the detection module 42 then determines, via said 3-dimensional coordinate system, the direction of movement of the object, in particular of the at least one finger 34, and the distance of the object, in particular of the at least one finger 34, from the reference, typically associated with the screen 22.

After calculating the direction M, the display device 30 proceeds to the next step 120, in which it determines, via its determination module 44, the area 48 based on the direction M of the movement of the at least one finger 34 towards the screen 22, said area 48 typically including at least one icon 32. The area 48 determined is, for example, an area centered on the intersection between the direction M of movement and the surface of the display screen 22.

Following the determination step 120, the display device 30 controls, via its control module 50, a change in appearance of the area 48 determined in the previous determination step 120. The appearance modification is typically an enlargement of the area 48, and optionally a highlighting and/or color modification of the area 48.

In this control step 130, the change in appearance is preferably controlled with increasing intensity as the distance between the display screen 22 and the user's hand 36, in particular their finger 34, decreases.

Even more preferably, this change in appearance is performed with a higher intensity for the icon 32 that is closest to the center of the area 48, determined in the previous determination step 120.

In this control step 130, the controlled change in appearance is for example temporary, such change in appearance typically being controlled as long as the distance between the display screen 22 and the detected finger 34, in particular the end of that finger 34 that is closest to the display screen 22, is less than the predefined hold threshold, described above. Alternatively, this change in appearance is temporary by being controlled for the predefined period of time described above.

After the control step 130, if the user 16 has made a tactile selection of a respective icon 32 displayed on the display screen 22, in particular an icon 32 whose appearance is changed as a result of the control step 130, then the display device 30 proceeds to the next step 140 in which it acquires, via its acquisition module 52, said tactile selection.

In addition, during this acquisition step 140, the acquisition module 52 also generates an acquisition confirmation signal for the user 16, in order to inform them that their tactile selection of the icon 32 has been taken into account by the display device 30. This acquisition confirmation signal is, for example, a vibratory signal, such as a haptic signal or a mechanical vibration; a visual signal; or a sound signal.

At the end of the acquisition step 40, the display device 30 returns to the display step 100.

Alternatively, if at the end of the control step 130, no tactile selection is made by the user 16, then the display device 30 returns directly to the display step 100.

In the example of FIG. 3, schematically representing four situations of interaction between the display system 20 and a finger 34 of the user 16, namely a first situation S1, a second situation S2, a third situation S3 and a fourth situation S4, the first situation S1 corresponds to the case where the hand 36 of the user 16 is too far away from the display screen 22, so that no approaching movement towards the screen 22 is detected by the detection module 42 during the detection step 110.

In the second situation S2, the user 16 moves their hand 36 closer to the display screen 22 in the direction M. In FIG. 3, the final position of the hand 36 is shown as a solid line, and the initial position of the hand 36 is shown as a dashed line. In this second situation S2, the detection module 42 detects this approaching movement of the hand 36, and then calculates the direction M of this movement. The determination module 44 then determines that the area 48, calculated according to the direction M and corresponding to this approach movement, is the one with the two icons 32 at the bottom left of the page 46. Then, the control module 50 controls a change in appearance of the two icons 32 included in the determined area 48, the change in appearance illustrated in FIG. 3 for the second situation S2 being an enlargement of said icons 32. In addition, the change in appearance is performed with greater intensity for the icon 32 near the lower-left corner of the page 46 than for the other icon included in the area 48, this lower-left icon 32 being the one closest to the center of the area 48, in particular to a point of intersection between the direction M of movement and the surface of the display screen 22.

In the third situation S3, the user 16 then performs a lateral movement with their hand 36 along the direction M which is then substantially parallel to the display screen 22. In this third situation S3, the detection module 42 detects that the hand 36 is still close to the screen 22, and then calculates the direction M of the movement performed by the hand 36, in particular by the finger 34. The determination module 44 then determines a new area 48 according to the direction M of the movement. In the example shown in FIG. 3, the determination module 44 determines that in the third situation S3 the direction M of the movement is substantially parallel to the screen 22 and is lateral, so that the newly determined area 48 is laterally offset, here to the right, from the area 48 determined in the second situation S2. The control module 50 then controls a change in appearance of the three icons 32 included in the area 48 determined in this third situation S3. This change in appearance is preferably also carried out with a higher intensity for the icon 32 located in the center of the determined area 48. In this third situation S3, the change in appearance is also an enlargement of the three icons 32 within the determined area 48, and the enlargement is then greater for the icon 32 in the center of this area 48.

The fourth situation S4 corresponds to the case where the user, after having shifted their hand 36 laterally to the left, brings it closer to the screen 22, along the direction M, in order to carry out at the end of the movement a tactile selection of the icon 32 whose appearance has been modified the most. In this fourth situation S4, the detection module 42 then detects this additional approaching movement of the hand 36, and in particular of the at least one finger 34, towards the screen 22; then calculates the direction M of said movement. The determination module 44 then determines, according to the direction M of the detected movement, the area 48 including at least one icon 32, and in particular three icons 32 in the example of this FIG. 3. The control module 50 then controls the change in appearance of the icon(s) 32 included in the determined area 48. The change in appearance is preferably furthermore more intense as the distance between the screen 22 and the hand 36, and in particular the finger 34, decreases. In the example of FIG. 3, and in the fourth situation S4, the dimensions of the icon(s) 32 included in the area 48 then increase as the user 16 moves their hand 36, and in particular their finger 34, closer to the display screen 22.

In this fourth situation S4, the user 16 also tactilely presses the icon 32 in the center of the area 48 at the end of their movement, and the acquisition module 52 then acquires the tactile selection of this icon 32, made by the user 16. The icon 32 selected by the user 16 is then typically the one whose appearance is modified, this modification of appearance making it possible to highlight this icon 32, and to facilitate its selection by the user 16, thus reducing the cognitive load for the user 16.

Thus, the display system 20, and in particular the display device 30, makes it possible to help the user 16 to identify and then more easily select the icon 32 corresponding to a function, or feature, that they wish to control, i.e. activate or launch.

This further reduces the safety risk due to distraction of the user 16, especially when the display system 20 is carried in the vehicle 10 and the user 16 is the driver of said vehicle 10.

With the display device 30, the detection of the movement of the at least one finger 34 towards the screen 22 is carried out from the at least two images taken by the image sensor 24, which allows for early detection, compared to that carried out via a capacitive sensor with the display device of the prior art.

Preferably, the detection of the movement is carried out as soon as the distance between the user's finger 34 and the display screen 22 is less than the predefined detection threshold, this detection threshold being of the order of a few centimeters. The skilled person will then understand that the distance between the finger 34 and the screen 22 is more precisely the distance between the end of the finger 34, i.e. the tip of the finger 34, and the screen 22.

The direction M of movement is also preferably calculated from the end of the at least one finger 34, i.e. the tip of the at least one finger 34, and even more preferably only from the end of the at least one finger 34. Said direction M of movement is then calculated solely from the trajectory of the tip of the or each finger 34, this trajectory being determined from said at least two images taken by the image sensor 24. Thus, the area 48 on the display 22 determined according to the direction M of the movement is much more reliable, as it is determined according to the trajectory of the fingertip.

Even more preferably, the change in appearance of the area 48 pointed to by the finger 34 of the user 16, i.e. the area 48 lying in the direction of movement of the at least one finger 34, is effected with increasing intensity as the distance between the finger 34 and the screen 22 decreases, thereby providing the user 16 with an even better indication of the area 48 to which their finger 34 is pointing, which indication becomes increasingly distinct as the finger 34 approaches the screen 22. If this area 48 does not correspond to what the user 16 wishes to select, then they can easily shift their finger 34 laterally so that it points to another area 48, which will then cause a change in appearance of this other area 48, corresponding to the new direction of movement of the at least one finger 34.

The display device 30 and the display method also make it possible to reduce the risk of an erroneous selection of an icon 32, for example due to a deformation of the roadway on which the vehicle 10 is travelling at the time the user 16 selects the icon 32. This reduction in the risk of mis-selection is particularly effective when the change in appearance is an enlargement of the icon 32, especially as the change in appearance increases in intensity as the distance between the finger 34 and the display screen 22 decreases.

It is thus conceived that the electronic display device 30 and the display method make it possible to facilitate the selection of an icon 32 displayed on the screen 22, and thus to reduce the cognitive load for the user 16, which limits the risks of an accident of the vehicle 10 when the electronic display device 30 is on board the vehicle 10 and the user 16 is typically the driver of said vehicle.

1. An electronic device for displaying data on a display screen, the device being adapted to be connected to the display screen and to an image sensor, the image sensor being adapted to capture at least two images of a user of the display screen, the device comprising:
a display module configured to display the data on the display screen;
a detection module configured to detect, via the at least two images taken, a movement towards said screen by at least one finger of the user, and then to calculate a direction of the movement;
a determination module configured to determine, from a page displayed on the screen and depending on the direction of movement, an area of the screen corresponding to said direction; and
a control module configured to control an enlargement of said area when said at least one finger approaches the screen.

2. The device according to claim 1, wherein the detection module is configured to detect a distance between said at least one finger and said display, and the control module is configured to control the enlargement of said area when said distance is below a predefined threshold.

3. The device according to claim 1, wherein the movement is a substantially rectilinear movement.

4. The device according to claim 1, wherein the detection module is configured to calculate the direction of movement from a tip of the at least one finger.

5. The device according to claim 4, wherein the direction of movement is calculated only from the tip of the at least one finger.

6. The device according to claim 1, wherein the control module is configured to control the enlargement of said area with increasing intensity as said at least one finger moves closer and closer to the screen.

7. The device according to claim 1, wherein the control module is configured to further control highlighting and/or color modification of said area.

8. The device according to claim 1, wherein the display screen is a touch screen, and the device further comprises an acquisition module configured to acquire a touch selection, from the user, of an icon displayed in said area.

9. The device according to claim 8, wherein the acquisition module is further configured to generate a signal to the user confirming the acquisition of the selection.

10. The device according to claim 9, wherein the signal is selected from the group consisting of: a vibratory signal, a visual signal and an audible signal.

11. An electronic data display system, the system comprising a display screen, an image sensor adapted to capture at least two images of a user of the display screen, and an device for displaying electronic data on the display screen, the electronic display device being according to claim 1, and the electronic display device being connected to the display screen and to the image sensor.

12. A vehicle comprising an electronic data display system, the electronic display system being according to claim 11.

13. A method for displaying data on a display screen, the method being implemented by an electronic display device adapted to be connected to the display screen and to an image sensor, the image sensor being adapted to capture at least two images of a user of the display screen, the method comprising:
displaying the data on the display screen;
detecting, via the at least two images taken, a movement towards said screen by at least one finger of the user, and then calculating a direction of the movement;
determining, among a page displayed on the screen and depending on the direction of the movement, an area of the screen corresponding to said direction;
controlling an enlargement of said area as said at least one finger approaches the screen.

14. A non-transitory computer-readable medium including a computer program comprising software instructions which, when executed by a computer, implement the method according to claim 13.
